(19) United States
(12) Patent Application Publication
(10) Pub. No.: US 2007/0132681 A1
(43) Pub. Date: Jun. 14, 2007

(54) Passive micro-mirror-array spatial light modulation

(76) Inventor: Chih-Liang Chen, Saratoga, CA (US)

Correspondence Address: FISH & RICHARDSON P.C., PO BOX 1022, MINNEAPOLIS, MN, 55440-1022, US

(21) Appl. No.: 11/299,232

(22) Filed: Dec. 9, 2005

(51) Int. Cl. G09G 3/34

(52) U.S. Cl. 345/85

(57) ABSTRACT

A passive spatial light modulator device includes a plurality of micro mirrors hinged over a pivot point supported by a substrate. A micro mirror includes a conductive surface on a lower surface and a first electrode situated under the conductive surface. The micro mirror can be selectively tilted about its pivot point by a first electric pulse applied to a mirror-reset line in connection with the conductive surface of the micro mirror and a second electric pulse applied to a bit line in connection with the first electrode under the micro mirror.

### BACKGROUND

The present specification relates to spatial light modulators.

Liquid crystal display (LCD) and micro mirror display (MMD) are two fastest growing technologies in the display industry. Applications of LCD and MMD include, for example, cell phones, computer monitors, and televisions. Small-size LCDs can include passive Super-Twist-Nematic (STN) displays or active Twisted Nematic (TN) displays. The maximum size of the LCDs is usually limited by the size and the costs of the manufacturing equipments.

The MMD is a type of spatial light modulator (SLM). The MMD is a projection display that operates by tilting micro mirrors in a mirror array. Each individual mirror in the array can tilt around a torsion hinge to deflect the incident light to a predetermined exit direction. The mirror tilting is actuated by selectively applying an electrostatic torque to the mirror. The light is turned “on” or “off” by selectively tilting the individual mirrors and mechanically stopping the mirrors at specific landing positions with precise deflection angles. A functional micro mirror array requires low contact stiction forces at the mechanical stops and high efficiency of electrostatic torques to control timing, to overcome surface contact adhesion, and to ensure robustness and reliability. A high performance spatial light modulator for display application produces high brightness and high contrast ratio videos images.

A conventional MMD display implements active display technology. That is, each individual micro mirror is driven by a separate driver. The drivers and addressing electronics are usually provided in a backplane layer under the micro mirror array. The micro mirrors are selectively tilted by the drivers to project light in or outside of the displayed image. Each micro mirror is assigned to project light to a particular pixel of a display device.

### SUMMARY

In one general aspect, the present invention features a passive spatial light modulator device that includes a plurality of micro mirrors. Each micro mirror is hinged over a pivot point supported by a substrate and comprising a conductive surface on a lower surface. The device includes a plurality of first electrodes. Each first electrode corresponds to a respective micro mirror and is situated under the conductive surface of one of the corresponding micro mirrors. The device includes a plurality of conductive mirror-reset lines, each being connected with the conductive surfaces of at least two of the plurality of micro mirrors. The device includes a plurality of conductive bit lines, each being connected to the first electrodes corresponding to one of the at least two micro mirrors. The micro mirror can be selectively tilted about its pivot point by a first electric pulse applied to the mirror-reset line in connection with the conductive surface of the micro mirror and a second electric pulse applied to the bit line in connection with the first electrode under the micro mirror.

In another general aspect, the present invention features a passive spatial light modulator device that includes a plurality of micro mirrors disposed in an array over a substrate. Each of the micro mirrors is hinged over one or two pivot points supported by the substrate and includes a conductive surface. The device includes one or more electrodes over the substrate under each of the micro mirrors. At least one of the micro mirrors is configured to be tilted about the pivot point when a predetermined electric voltage bias is applied between the conductive surface on the micro mirror and at least one of the electrodes associated with the micro mirror. The device includes a plurality of substantially parallel conductive mirror-reset lines each connected with the conductive surfaces on a row of micro mirrors in the array. The device includes a plurality of substantially parallel conductive bit lines each connected to the electrodes situated under a column of micro mirrors in the array. At least one of the micro mirrors is configured to be selectively tilted by a first electric pulse applied to the mirror-reset line in connection with the conductive surface of the micro mirror and a second electric pulse applied to the bit line in connection with one of the electrodes situated under the micro mirror.

In another general aspect, the present invention features a passive spatial light modulator device that includes a plurality of micro mirrors micro mirrors disposed in a M by N array over a substrate. M and N are integer numbers. At least one of the micro mirrors is hinged over a pivot point supported by the substrate and includes a conductive surface. The device includes a first electrode and a second electrode over the substrate and situated under each of the micro mirrors. At least one of the micro mirrors is configured to be tilted about the pivot point when a predetermined electric voltage bias is applied between the conductive surface on the micro mirror and at least one of the first electrode and the second electrode corresponding to the micro mirror. The device includes N number of rows of conductive mirror-reset lines, each being connected with the conductive surfaces on a row of micro mirrors in the M by N array. The device includes 2M number of columns of conductive bit lines, each being connected to the first electrodes or the second electrodes under a column of micro mirrors in the M by N array. At least one of the micro mirrors is configured to be selectively tilted by a first electric pulse applied to the mirror-reset line in connection with the conductive surface of the micro mirror and a second electric pulse applied to the bit line in connection with the first electrode under the micro mirror.

In another general aspect, the present invention features a method for displaying a digital image using a passive spatial light modulator device, which includes: a plurality of electrically tiltable micro mirrors disposed in an array over a substrate; one or more electrodes over the substrate under each of the micro mirrors; a plurality of substantially parallel conductive mirror-reset lines each connected with the conductive surfaces on a row of micro mirrors in the array; and a plurality of substantially parallel conductive bit lines each connected to electrodes situated under a column of micro mirrors in the array. The method includes applying bit line voltages to the conductive bit lines for a first update of the mirror orientations in a first row of micro mirrors. The method includes applying a mirror reset pulse to the first mirror-reset line corresponding to the first row of micro mirrors to selectively change the mirror orientations of the micro mirrors in the first row of micro mirrors in the first update of the mirror orientations in the first row of micro mirrors.

In another general aspect, the present invention relates to a computer program product for controlling a passive spatial light modulator device, which comprises a plurality of electrically tiltable micro mirrors disposed in an array over a substrate; one or more electrodes over the substrate under each of the micro mirrors; a plurality of substantially parallel conductive mirror-reset lines each connected with the conductive surfaces on a row of micro mirrors in the array; and a plurality of substantially parallel conductive bit lines each connected to electrodes situated under a column of micro mirrors in the array. The computer program product includes instructions operable to cause a processor to perform a method that includes applying bit line voltages to the conductive bit lines for a first update of the mirror orientations in a first row of micro mirrors; and applying a mirror reset pulse to the first mirror-reset line corresponding to the first row of micro mirrors to selectively change the mirror orientations of the micro mirrors in the first row of micro mirrors in the first update of the mirror orientations in the first row of micro mirrors.

Implementations of the system can include one or more of the following. The plurality of micro mirrors can be disposed in a two-dimensional array having a plurality of rows of micro mirrors and a plurality of columns of micro mirrors. The micro mirrors having their respective first electrodes connected to a conductive bit line can be distributed in a row. The plurality of conductive bit lines can be substantially parallel to each other. The micro mirrors having their respective conductive surfaces connected to a conductive mirror-reset line can be distributed in a column. The plurality of mirror-reset lines can be substantially parallel to each other. The plurality of rows of micro mirrors can be substantially orthogonal to the plurality of columns of the micro mirrors. The passive spatial light modulator device can further include a plurality of second electrodes over the substrate, each corresponding to a respective micro mirror and being situated under the conductive surface of one of the micro mirrors. The first electrode and the second electrode corresponding to a micro mirror can be disposed under two different sides of the micro mirror. The first electrode and the second electrode under a micro mirror can be separately connected to a first bit line and a second bit line. The micro mirror can be configured to be selectively tilted by applying a first electric pulse to the mirror-reset line, a second electric pulse to the first bit line, and a ground to the second bit line. The micro mirror can be configured to be flipped among two or more orientations by varying the first electric pulse and the second electric pulse. The first pulse and the second pulse can include only positive or ground voltages. The second pulse can include only positive or ground voltages and the first pulse includes voltages in the range of −20V to +20V. The tilt of the micro mirror about its pivot produced can be dependent on the initial orientation of the micro mirror relative to the first electrode corresponding to the micro mirror. The micro mirrors can include reflective upper surfaces configured to reflect incident light.

Embodiments may include one or more of the following advantages. An advantage of the disclosed system and methods is that each provides a simple and low-cost passive spatial light modulator device based on a micro-mirror array (MMA). The micro mirrors are driven by rows of mirror-reset lines and columns of data lines, rather than by separate drivers for individual micro mirrors as in the active micro-mirror SLMs. Manufacturing complexity and cost are thus significantly lower than active micro mirror display devices. Moreover, the addressing and driving electronics can be further simplified by driving the micro mirrors with only positive waveforms.

Another advantage of the disclosed passive MMA device is that it can provide robust performance in wider temperature and humidity ranges comparing to the LCD or Organic Light Emitting Diode (OLED) displays. The disclosed passive MMA device is suitable for applications at high or low temperature where LCD and OLED are known to suffer damages.

Another advantage of the disclosed passive MMA device is that it is compatible with different types of micro mirror designs and mirror actuation mechanisms, including silicon based micro mirrors that can be tilted under electrostatic forces. The disclosed passive MMA devices are applicable to a wide range of applications such as head-up displays (HUD) in cars, displays for hand held devices, and large graphic displays. The disclosed passive MMA device is suitable for large-format displays at low frame refresh rate and small-format displays with high frame refresh rate.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

FIG. 1A illustrates the functional schematics of a passive micro-mirror-array device.

FIG. 1B illustrates the orientations of the micro mirrors as a result of the voltage pulses as illustrated in FIG. 1A.

FIG. 2A illustrates the voltage waveforms for addressing and driving the micro mirrors in FIG. 1A.

FIG. 2B illustrates alternative voltage waveforms for addressing and driving the micro mirrors in FIG. 1A.

FIG. 2C illustrates voltage waveforms comprising only positive voltages for addressing and driving the micro mirrors in FIG. 1A.

FIG. 3 illustrates the layout of a passive micro-mirror array.

FIG. 4 illustrates the calculation of the least significant bit of the display time for the passive micro-mirror array of FIG. 3.

FIG. 5 is an exemplified flow chart for changing the orientation states of the micro mirrors in the passive micro-mirror-array device of FIG. 1A.

Like reference numbers and designations in the various drawings indicate like elements.

### DETAILED DESCRIPTION

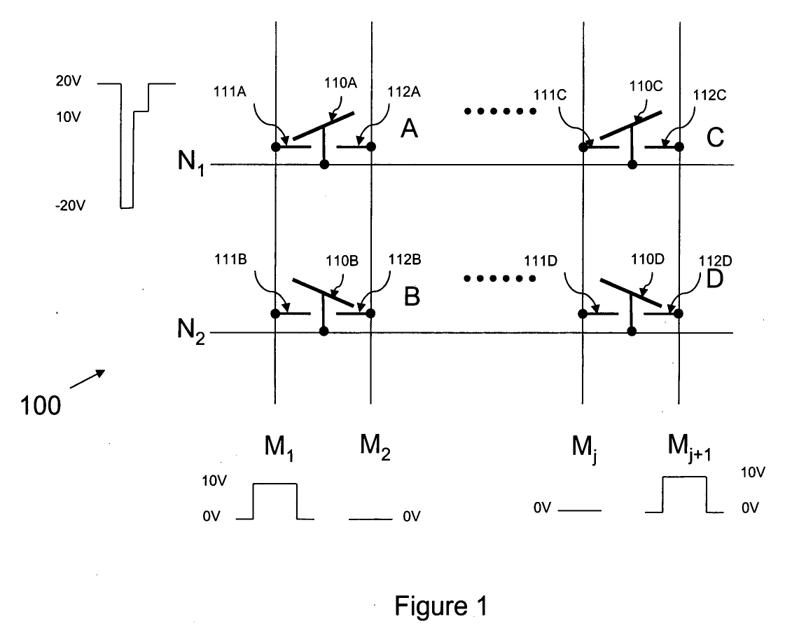

FIG. 1A shows a schematic of an MMA 100 having a plurality of elements, for example, elements A, B, C and D. The plurality of elements can be distributed in an array of rectangular cells as shown in FIG. 1A. The elements can also be distributed in other types of periodic patterns, for example, those that can accommodate hexagonal cells or diamond cells. The patterns can be non-periodic. Each element comprises a micro mirror hinged over a hinge support post joined to a substrate and a pair of electrodes over the substrate. The pair of surface electrodes is respectively positioned under the left and the right sides of the micro mirror. The micro mirror includes a conductive lower surface facing the surface electrodes. The micro mirror can tilt around a pivot point defined by the hinge over the hinge support. The two substrate electrodes are respectively located on opposite sides of the hinge. For example, element A includes a micro mirror 110A and a pair of substrate electrodes 111A and 112A underneath each side of the micro mirror 110A. Element B includes a micro mirror 110B and a pair of substrate electrodes 111B and 112B.

The MMA 100 is compatible with different micro mirror designs and flipping mechanisms. The micro mirrors can include a mirror plate hinged over one or two hinges supported by separate hinge support posts. The top surface of the mirror plate is reflective for directing an incident light beam. The hinges can be hidden under the mirror plate to maximize the effective spatial light modulator area. The mirror plate, the hinges, and hinge support posts can be fabricated from a silicon substrate using semiconductor micro-fabrication techniques. Details of suitable hinged micro mirrors are disclosed in the above-referenced U.S. patent applications.

In a display application, each of the micro mirrors at the elements A, B, C, and D can modulate incident light and in conjunction with each other reflect light to form an image on a raster display device. A light beam reflected from the micro mirrors can be projected to an assigned pixel of a display surface when the micro mirror is oriented at an “on” state. The light beam reflected can alternatively be directed to a light absorber away from the display when the micro mirror is oriented at an “off” state. The micro mirror can tilt in the upper left and upper right directions in the “on” state and the “off” state as shown in elements A and B in FIG. 1A. The oppositely tilted directions maximize the angular differences between the two states, which is helpful to design flexibility and reduction of stray light in the display device.

In contrast to the active SLM based micro mirror devices, the passive MMA 100 does not require a driver for each micro mirror. Instead, the micro mirrors 110A-110D are addressed and driven by a combination of rows of mirror reset lines (MRST) N₁ or N₂ and columns of bit lines M₁, M₂. . . Mⱼ, and Mⱼ₊₁. The mirror reset lines (MRST) N₁ and N₂ are the x-addressing lines for a row of mirrors 110A and 110C and another row of mirrors 110B and 110D. Each MRST line can be driven by a separate driver to supply voltage pulses to the conductive surfaces of a row of mirrors. For example, the MRST line N₁ can supply high voltage pulses the micro mirrors at elements A and C.

The y-addressing lines include pairs of bit lines M₁ and M_{2 . . .} Mⱼ and Mⱼ₊₁, which are depicted in FIG. 1A as being disposed in the vertical direction. Each pair of bit lines is respectively connected to the pairs of substrate electrodes under the micro mirrors in a column. For example, the bit line M₁ is connected with the substrate electrode 111A in element A and the substrate electrode 111B in element B. Electric voltage pulses applied by a driver to the bit line M₁ can thus change the electric potential at the substrate electrodes 111A and 111B in the column of elements. Similarly, the bit line M₂ is connected with electrodes 112A and 112B. The bit line Mⱼ is connected with substrate electrodes 111C and 111D. The bit line Mⱼ₊₁, is connected with electrodes 112C and 112D.

The micro mirrors 110A-110D can include aluminum, silicon, polysilicon, amorphous silicon, and aluminum-silicon alloys. The micro mirrors can also comprise two or more layers of different material compositions. The width of the micro mirror can be in the range of 2 to 20 microns. The thickness of the micro mirror can be in the range of 0.1 to 1.0 micron. A known physical property of the micro mirrors at these small dimensions is that the loss of elasticity of the micro mirrors. In general, the elastic constants of a solid object are proportional to certain powers of the dimensions of the object. In particular, the torsional elasticity decreases as the width of the torsion hinge is reduced. At the above described dimensions of the micro mirrors, the torsional elasticity is no longer strong enough to restore a tilted micro mirror to its initial flat state. A micro mirror will stay at its initial orientation until it is tilted by a large enough external force.

The tilting of the micro mirror 110A-110D in the MMA 100 is achieved by creating an imbalance of electrostatic forces on the two sides of the micro mirrors. Electric potential differences can be established between the micro mirrors 110A-110D and their corresponding surface electrodes when voltage pulses are applied along the bit lines and the mirror reset lines. Electrostatic forces are produced between the surface electrodes and the micro mirror as a result of the electric potential differences. The two bit lines connected to the two surface electrodes can receive different voltage pulses. The electrostatic forces experienced on the two sides of the micro mirror can thus be different. For example, a repulsive force can be exerted on one side of the mirror and an attractive force on the other. The imbalance of the electrostatic forces on the two sides of the micro mirror can flip the micro mirror to a different orientation.

The magnitudes of the attractive force and the repulsive forces are also dependent on the distances between the micro mirror and each of the surface electrodes. Because the micro mirrors 110A-110D are usually tilted at the initial state, the magnitude of the force is larger on the side of the mirror that is closer to the corresponding substrate electrode. Thus, whether a mirror will flip or not is determined by the voltage levels on the bit lines and the mirror reset lines as well as the initial mirror orientation.

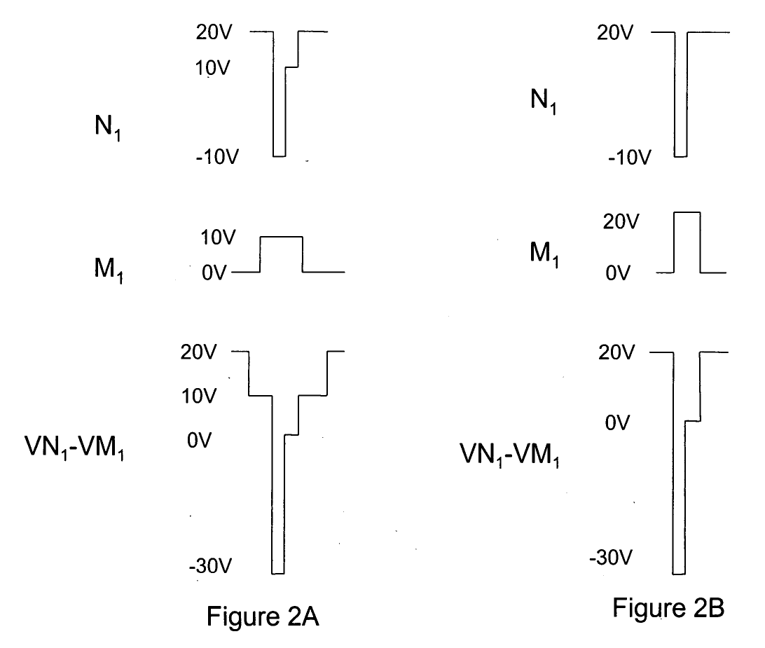

The flipping of the micro mirrors is now described using the voltage pulses illustrated in FIGS. 1 and 2A. The micro mirrors 110A and 110C initially both face upper left direction. The micro mirrors 110C and 110D face upper right direction. As previously discussed, the micro mirrors 110A, 110B, 110C, and 110D can maintain their respective initial orientations in the absence of significant external forces. A +10V voltage pulse is applied to the bit line Mⱼ and to the bit line Mⱼ₊₁, while the bit lines M₂ and Mⱼ are held at the ground level. The micro mirrors in a row are updated (or written) when a voltage pulse is applied to the corresponding MRST. The update of the micro mirrors allows the micro mirrors to change their tilt orientations. The change of tilt orientation of a micro mirror can determine the length of the duration that the micro mirror stays at an “on” or an “off” state. A bipolar waveform is applied to the MRST N₁. The bipolar waveform includes a transition from the standby voltage of +20V to −20V, back to a bit line voltage of +10V, finally returning to the standby voltage of +20V.

The potential difference between the micro mirror 110A and the surface electrode 111A is shown in the lower diagram in FIG. 2A. The micro mirror 110A is first attracted to the left surface electrode 111A by the −30V pulse in the potential difference. The micro mirror 110A then experiences a strong bounce-up force at the close distance when the potential difference switches to +10V and then +20V. The voltage pulsing sequence causes the micro mirror 110A to bounce and flip to face the upper right direction.

In contrast, the micro mirror 110C will not be subject to as large an attractive force from the electrode 112C during the pulse cycle at the MRST N₁. line because of the large gap between the micro mirror 110C and the electrode 112C. The voltage difference between the electrode 111C and the micro mirror 110C is also not large enough to flip mirror 110C when the bit line Mⱼ is not addressed. Thus, the micro mirror 110C will not be flipped. (Note that the application of the +10V pulse to the bit line Mⱼ₊₁, is not required to keep the mirror plate 110C from flipping because a mirror plate usually maintains its orientation in the absence a voltage pulse being applied to a bit line of the mirror plate. The application of the pulse to the bit line Mⱼ₊₁, serves to demonstrate that the mirror plate 110C will not flip despite the presence of the pulse because of the mirror plate 110C's orientation, i.e., titled to face the upper left direction.) Mirrors 110B and 110D will also stay at the original orientations because no MSRT pulse has been applied to the MRST N₂. (If the same mirror reset waveform is applied instead to the MRST N₂ line with the same voltage pulses applied to the bit lines, the micro mirror 110D will be flipped but mirror 110B will not be for the same reasons.)

In summary, the voltage pulses illustrated in FIGS. 1A and 2A act to cause the flipping of only the micro mirror 110A. As demonstrated, the micro mirror 110A can be selectively addressed and flipped by a set of pre-designed voltage pulses at the micro mirror reset lines and the bit lines without affecting the orientation of other micro mirrors.

An advantageous feature of the MMA 110 is that the bias voltages on the micro mirror and the surface electrodes are provided. by external drivers instead of internal drivers in the silicon substrate as in the active micro-mirror SLM devices. The bias voltages are thus not constrained by the silicon devices and its fabrication processes as for the active micro mirror drivers. The voltage bias between the micro mirrors and the electrodes can be kept the same when the voltage levels on the bit lines and the MRST pulses are simultaneously increased. The MRST voltage can be changed to a moderate range of −10V to +20V if the voltage in the bit line is increased to +20V, as shown in FIG. 2B. Such moderate MRST pulses can be provided by lower-cost driver chips, significantly reducing the cost of the MMA devices. In another example, as shown in FIG. 2C, the MRST voltage can be raised to the positive range of 0V to +30V if the voltage in the bit line is increased to the range of +10V and +30V. The positive-voltage MRST pulses can further simplify circuit design and decrease fabrication costs.

The array of micro mirrors in the MMA 100 can be updated by various different schemes. The array of micro mirrors can be updated line by line. A micro mirror can be turned on, i.e., be tilted to a position that directs light at a pixel on a display, while another mirror in the same row can be turned off, i.e., be tilted to a position that directs light away from the display, by the same MRST pulse. A grayscale display image can be achieved by pulse width modulation (PWM), which generally changes the duration of a mirror's on time. The micro mirrors can be turned off automatically after turning on for a specified period of time to achieve the grey scale. For example, a brighter pixel in the display image corresponds to a wider pulse width that keeps the mirror at the “on” state for longer time. The specified period of “on” time can be binary weighted to define its accuracy. The least significant bit (LSB) of the display time in an MMA is the shortest duration for a mirror to stay at one orientation between the two successive writings. The LSB is governed by the frame update time and the number rows in the mirror array. The frame rate and the LSB determine the number of gray scales in the image displayed by the MMA.

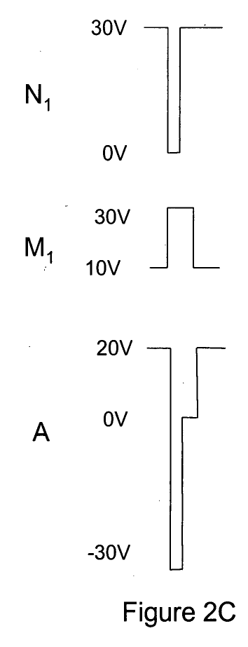

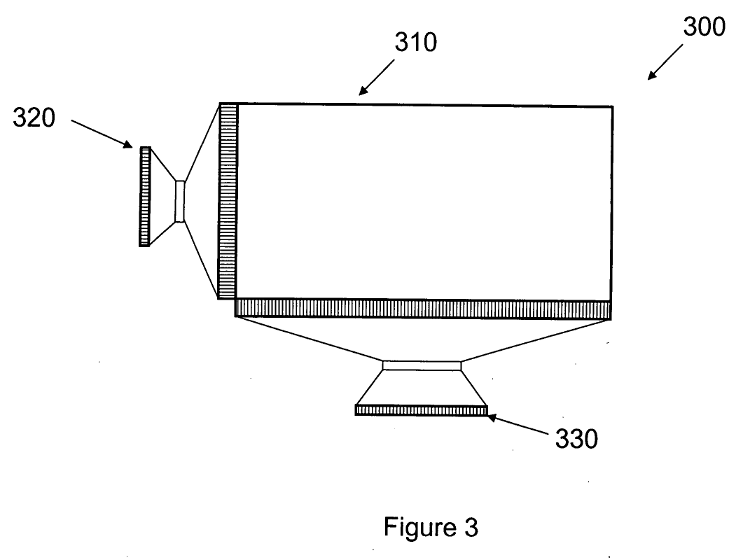

The relationship between the LSB, the frame rate, the MMA size, and the grey scale can be shown using the example of MMA 300 in FIG. 3. The MMA device 300 comprises an array 310 of micro mirrors distributed in 32 rows with 64 micro mirrors per row. The 32 mirror reset lines associated with the 32 rows of micro mirrors receive their drive signals from the shift registers 320. The 128 bit lines receive drive signals from their respective drivers through the shift registers 330. The mirror orientations are updated one row at a time by the MRST pulses. As shown in FIG. 4, the time for updating a row or a line of mirrors consists of two components: the time for applying a MRST pulse to the row of mirrors, and the time to load a line of new data into a shift register 330 for driving the bit lines. The durations of the MRST pulses are typically between 10 μs to 20 μs. The total MRST time for 32 lines is thus 32×20 μs=640 μs for a 20 μs MRST pulse duration. For a 20 MHz scan clock (50 ns clock cycle), the scan-in-data time for loading bit-line data the shift register 330 is 50 ns×64=3.2 μs. Since the data update for each row of mirrors can be pipelined while the previous lines are written, the data loading time is insignificant comparing to the mirror reset times. Thus the LSB time for the MMA 300 is approximately 640 μs.

The display bit depth can be determined by the LSB and the display frame rate. For example, if the MMA 300 has a 60 Hz frame rate for the display images, the number of gray levels is then 26 (=1/60 Hz/640 μs), which provides between 4 and 5 bits of bit depth at each displayed image pixel. The bit depth can be increased by shortening the MRST time. The size of the MMA display can be increased at the same frame rate by tiling up several 64×32 MMAs to allow micro mirrors in several MMA blocks to be updated in parallel.

The voltage of each of the 32 lines in the MMA 300 is controlled by a micro-controller that includes one or more computer processors. The micro-controller can execute computing instructions to provide proper line time and frame rate of an image. Furthermore, bit-line voltages at the shift register 330 are also controlled by a micro-controller to provide for proper mirror states to display appropriate pixel values for the display image.

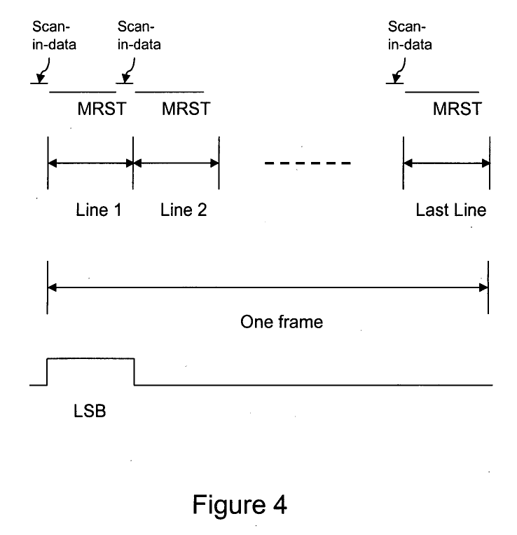

FIG. 5 is a flow chart that shows a process for changing the orientation states of the micro mirrors in the passive MMA 100. Digital data for setting the bit line voltages in the first update of the mirror orientations in the first row is first loaded to the shift register (step 510). The bit line voltages for updating the first row of mirrors are applied to the bit lines (e.g. from M₁, M₂. . . Mⱼ, Mⱼ₊₁, in FIG. 1) for the first update of the mirror orientations (step 520). A mirror reset pulse is applied to the first mirror reset line (e.g. N₁, in FIG. 1) to conduct the first update of the first row of micro mirrors (step 530). Steps 510-530 are then repeated in steps 540-560 for the first update of the second row of micro mirrors in MMA 100. Steps 510-530 are then repeated for the third and the fourth rows and so on, until the steps 570-590 for the first update of the last rows of the micro mirrors. The first update of the whole array of the micro mirrors is completed in steps 510-590. As discussed in relation with FIG. 4, the time for loading data to the shift registers (e.g., in step 540) can overlap with the mirror updating time for the previous row (e.g., in the step 530).

Steps 510-590 together take up the time in the duration of “Line 1” in FIG. 4. The duration in “Line 1” also corresponds to the Least Significant Bit for the light intensity at each pixel in the displayed image. For example, a micro mirror can be flipped to an “On”-state orientation in the first mirror update (in the first line) to begin to project light to the respective pixel in the image display. That micro mirror can be flipped to an “Off”-state orientation at the second mirror update (in the second line). The “On” time for this micro mirror is therefore 1 Least Significant Bit, that is, the shortest “On” time of a pixel in an image frame.

Steps 510-590 are repeated a number of times to complete an image frame as shown in the number of lines in FIG. 4. The total number of updates (or number of lines) in an image frame gives the number of intensity levels (i.e. bit depth) for the image displayed by the array of micro mirrors. The above described steps for displaying one image frame can be repeated to display of a sequence of video image frames or a sequence of static images.

It should be noted that FIG. 4 is meant to illustrate an example of addressing and flipping micro mirrors in a passive MMA. The invention system and methods are compatible with many other schemes of driving micro mirrors in an image frame.

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer-readable medium, e.g., a machine-readable storage device, a machine-readable storage medium, a memory device, or a machine-readable propagated signal, for execution by, or to control the operation of, data processing apparatus. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry. The present invention has been described in terms of a preferred embodiment. The invention, however, is not limited to the embodiment depicted and described. Rather, the scope of the invention is defined by the appended claims.

What is claimed is:

1. A passive spatial light modulator device, comprising:
a plurality of micro mirrors, each micro mirror being hinged over a pivot point supported by a substrate and comprising a conductive surface on a lower surface;
a plurality of first electrodes, each first electrode corresponding to a respective micro mirror and being situated under the conductive surface of one of the corresponding micro mirrors;
a plurality of conductive mirror-reset lines each connected with the conductive surfaces of at least two of the plurality of micro mirrors; and
a plurality of conductive bit lines, each connected to the first electrodes corresponding to one of the at least two micro mirrors, wherein the micro mirror can be selectively tilted about its pivot point by a first electric pulse applied to the mirror-reset line in connection with the conductive surface of the micro mirror and a second electric pulse applied to the bit line in connection with the first electrode under the micro mirror.

2. The passive spatial light modulator device of claim 1, wherein the plurality of micro mirrors is disposed in a two-dimensional array having a plurality of rows of micro mirrors and a plurality of columns of micro mirrors.

3. The passive spatial light modulator device of claim 2, wherein the micro mirrors having their respective first electrodes connected to a conductive bit line are distributed in a row.

4. The passive spatial light modulator device of claim 3, wherein the plurality of conductive bit lines are substantially parallel to each other.

5. The passive spatial light modulator device of claim 2, wherein the micro mirrors having their respective conductive surfaces connected to a conductive mirror-reset line are distributed in a column.

6. The passive spatial light modulator device of claim 5, wherein the plurality of mirror-reset lines are substantially parallel to each other.

7. The passive spatial light modulator device of claim 2, wherein the plurality of rows of micro mirrors is substantially orthogonal to the plurality of columns of the micro mirrors.

8. The passive spatial light modulator device of claim 1, further comprising a plurality of second electrodes over the substrate, each corresponding to a respective micro mirror and being situated under the conductive surface of one of the micro mirrors.

9. The passive spatial light modulator device of claim 8, wherein the first electrode and the second electrode corresponding to a micro mirror are disposed under two different sides of the micro mirror.

10. The passive spatial light modulator device of claim 8, wherein the first electrode and the second electrode under a micro mirror are separately connected to a first bit line and a second bit line.

11. The passive spatial light modulator device of claim 10, wherein the micro mirror is configured to be selectively tilted by applying a first electric pulse to the mirror-reset line, a second electric pulse to the first bit line, and a ground to the second bit line.

12. The passive spatial light modulator device of claim 11, wherein the micro mirror is configured to be flipped among two or more orientations by varying the first electric pulse and the second electric pulse.

13. The passive spatial light modulator device of claim 1, wherein the first pulse and the second pulse comprise only positive or ground voltages.

14. The passive spatial light modulator device of claim 1, wherein the second pulse comprise only positive or ground voltages and the first pulse includes voltages in the range of −20V to +20V.

15. The passive spatial light modulator device of claim 1, wherein the tilt of the micro mirror about its pivot produced is dependent on the initial orientation of the micro mirror relative to the first electrode corresponding to the micro mirror.

16. The passive spatial light modulator device of claim 1, wherein the micro mirrors comprise reflective upper surfaces configured to reflect incident light.

17. A passive spatial light modulator device, comprising:
a plurality of micro mirrors disposed in an array over a substrate, each micro mirror being hinged about a hinge member supported by the substrate, each micro mirror comprising a conductive surface;
one or more electrodes over the substrate under each of the micro mirrors, wherein at least one of the micro mirrors is configured to be tilted about the pivot point when a predetermined electric voltage bias is applied between the conductive surface on the micro mirror and at least one of the electrodes associated with the micro mirror;
a plurality of substantially parallel conductive mirror-reset lines each connected with the conductive surfaces on a row of micro mirrors in the array; and
a plurality of substantially parallel conductive bit lines each connected to the electrodes situated under a column of micro mirrors in the array, wherein at least one of the micro mirrors is configured to be selectively tilted by a first electric pulse applied to the mirror-reset line in connection with the conductive surface of the micro mirror and a second electric pulse applied to the bit line in connection with one of the electrodes situated under the micro mirror.

18. The passive spatial light modulator device of claim 17, wherein the first pulse and the second pulse comprise only positive or ground voltages.

19. The passive spatial light modulator device of claim 17, wherein the second pulse comprise only positive or ground voltages and the first pulse includes voltages in the range of −20V to 20V.

20. The passive spatial light modulator device of claim 17, wherein each of the electrodes situated under a common micro mirror is connected to a separate bit line.

21. The passive spatial light modulator device of claim 17, wherein two electrodes under the common micro mirror are separately connected to a first bit line and a second bit line.

22. The passive spatial light modulator device of claim 21, wherein the micro mirror is configured to be selectively tilted by applying a first electric pulse to the mirror-reset line, a second electric pulse to the first bit line, and a ground to the second bit line.

23. A passive spatial light modulator device, comprising:
a plurality of micro mirrors micro mirrors disposed in a M by N array over a substrate, wherein M and N are integer numbers and at least one of the micro mirrors being hinged over a pivot point supported by the substrate and comprising a conductive surface;
a first electrode and a second electrode over the substrate and situated under each of the micro mirrors, wherein at least one of the micro mirrors is configured to be tilted about the pivot point when a predetermined electric voltage bias is applied between the conductive surface on the micro mirror and at least one of the first electrode and the second electrode corresponding to the micro mirror;
N number of rows of conductive mirror-reset lines each connected with the conductive surfaces on a row of micro mirrors in the M by N array; and
2M number of columns of conductive bit lines each connected to the first electrodes or the second electrodes under a column of micro mirrors in the M by N array, wherein at least one of the micro mirrors is configured to be selectively tilted by a first electric pulse applied to the mirror-reset line in connection with the conductive surface of the micro mirror and a second electric pulse applied to the bit line in connection with the first electrode under the micro mirror.

24. The passive spatial light modulator device of claim 23, wherein the first pulse and the second pulse comprise only positive or ground voltages.

25. The passive spatial light modulator device of claim 23, wherein at least one of the micro mirrors is configured to be selectively tilted by a first electric pulse applied to the mirror-reset line in connection with the conductive surface of the micro mirror, a second electric pulse applied to the bit line in connection with the first electrode under the micro mirror, and a ground to the bit line in connection with the second electrode under the micro mirror.

26. A spatial light modulator, comprising:
a plurality of cells each comprising a micro mirror device having a tiltable micro mirror, a first electrode, and a second electrode, wherein the tiltable micro mirror is configured to change orientation when the electric voltages at the first electrode, the second electrode, or both electrodes are changed to predetermined threshold values;
a first conductive line connected to the first electrodes of a first cell and a second cell in the plurality of cells;
a second conductive line connected to the second electrode of the first cell; and
a third conductive line connected to the second electrode of the second cell, wherein the micro mirror in the first cell and not the micro mirror in the second can be caused to selectively change orientation when the electric voltages of the first line and the second line are changed while the electric voltage of the third line is not changed.

27. A method for displaying a digital image using a passive spatial light modulator device comprising a plurality of electrically tiltable micro mirrors disposed in an array over a substrate; one or more electrodes over the substrate under each of the micro mirrors; a plurality of substantially parallel conductive mirror-reset lines each connected with the conductive surfaces on a row of micro mirrors in the array; and a plurality of substantially parallel conductive bit lines each connected to electrodes situated under a column of micro mirrors in the array, the method comprising:
applying bit line voltages to the conductive bit lines for a first update of the mirror orientations in a first row of micro mirrors; and
applying a mirror reset pulse to the first mirror-reset line corresponding to the first row of micro mirrors to selectively change the mirror orientations of the micro mirrors in the first row of micro mirrors in the first update of the mirror orientations in the first row of micro mirrors.

28. The method of claim 27, wherein applying bit line voltages to the conductive bit lines for a first update of the mirror orientations in a first row of micro mirrors comprises:
loading digital data to a shift register for setting voltages for the conductive bit line in a first update of mirror orientations in a first row of mirrors.

29. The method of claim 27, further comprising:
applying bit line voltages to the conductive bit lines for a first update of the mirror orientations in a second row of micro mirrors; and
applying a mirror reset pulse to the second mirror-reset line corresponding to the second row of micro mirrors to selectively change the mirror orientations of the micro mirrors in the second row of micro mirrors in the first update of the mirror orientations in the second row of micro mirrors.

30. The method of claim 27, further comprising:
applying bit line voltages to the conductive bit lines for a second update of the mirror orientations in a first row of micro mirrors; and
applying a mirror reset pulse to the first mirror-reset line corresponding to the first row of micro mirrors to selectively change the mirror orientations of the micro mirrors in the second row of micro mirrors in the second update of the mirror orientations in the first row of micro mirrors.

31. A computer program for controlling a passive spatial light modulator device comprising a plurality of electrically tiltable micro mirrors disposed in an array over a substrate; one or more electrodes over the substrate under each of the micro mirrors; a plurality of substantially parallel conductive mirror-reset lines each connected with the conductive surfaces on a row of micro mirrors in the array; and a plurality of substantially parallel conductive bit lines each connected to electrodes situated under a column of micro mirrors in the array, the computer program comprising the steps of:
applying bit line voltages to the conductive bit lines for a first update of the mirror orientations in a first row of micro mirrors; and
applying a mirror reset pulse to the first mirror-reset line corresponding to the first row of micro mirrors to selectively change the mirror orientations of the micro mirrors in the first row of micro mirrors in the first update of the mirror orientations in the first row of micro mirrors.

32. The computer program of claim 31, wherein applying bit line voltages to the conductive bit lines for a first update of the mirror orientations in a first row of micro mirrors comprises:
loading digital data to a shift register for setting voltages for the conductive bit line in a first update of mirror orientations in a first row of mirrors.

33. The computer program of claim 31, further comprising the steps of:
applying bit line voltages to the conductive bit lines for a first update of the mirror orientations in a second row of micro mirrors; and
applying a mirror reset pulse to the second mirror-reset line corresponding to the second row of micro mirrors to selectively change the mirror orientations of the micro mirrors in the second row of micro mirrors in the first update of the mirror orientations in the second row of micro mirrors.

34. The computer program of claim 31, further comprising the steps of:
applying bit line voltages to the conductive bit lines for a second update of the mirror orientations in a first row of micro mirrors; and
applying a mirror reset pulse to the first mirror-reset line corresponding to the first row of micro mirrors to selectively change the mirror orientations of the micro mirrors in the second row of micro mirrors in the second update of the mirror orientations in the first row of micro mirrors.
